(19) United States
(12) Patent Application Publication
(10) Pub. No.: US 2026/0133647 A1
(43) Pub. Date: May 14, 2026

(54) TOUCH-PANEL EMBEDDED DISPLAY APPARATUS

(71) Applicant: Sharp Display Technology Corporation, Kameyama City (JP)

(72) Inventors: Takenori MARUYAMA, Kameyama City (JP); Kazutoshi Kida, Kameyama City (JP); Shinji Yamagishi, Kameyama City (JP); Takuma Yamamoto, Kameyama City (JP); Yasuhiro Sugita, Kameyama City (JP); Hiroshi Fukushima, Kameyama City (JP)

(21) Appl. No.: 19/381,394

(22) Filed: Nov. 6, 2025

(30) Foreign Application Priority Data
Nov. 11, 2024 (JP) 2024-196870

(51) Int. Cl. G06F 3/041; G06F 3/044

(52) U.S. Cl. CPC G06F 3/0412; G06F 3/0418; G06F 3/044

(57) ABSTRACT

A touch-panel embedded display apparatus includes a pixel electrode, a counter electrode, a driving electrode, a detection electrode, and an intermediate electrode. The counter electrode is arranged to face the pixel electrode. The detection electrode forms capacitance with the driving electrode. The intermediate electrode is formed in the same layer as the layer where the counter electrode, the driving electrode, and the detection electrode are formed. The intermediate electrode is arranged between two of the counter electrode, the driving electrode, and the detection electrode.

### BACKGROUND

### 1. Field

The present disclosure relates to a touch-panel embedded display apparatus.

### 2. Description of the Related Art

The touch-panel embedded display apparatus disclosed in Japanese Unexamined Patent Application Publication No. 2022-114180 includes multiple driving electrodes, multiple detection electrodes, multiple pixel electrodes, and a touch detection driver. The touch detection driver does not supply, during a first time period, a touch detection driving signal to a first driving electrode overlapping in a plan view a first pixel electrode group supplied with a gate signal but supplies the touch detection driving signal to a second driving electrode overlapping in a plan view a second pixel electrode group not supplied with the gate signal. During the first time period, the first driving electrode operates as an electrode for displaying (a counter electrode (common electrode) facing the pixel electrodes).

To increase in size the touch-panel embedded display apparatus disclosed in Japanese Unexamined Patent Application Publication No. 2022-114180, the sizes of each driving electrode and each detection electrode may also be increased. The load of the driving electrodes (capacitance and resistance) and the load of the detection electrodes thus increase. An increase in the load may lead to difficulty in supplying the driving signal to the driving electrode. Specifically, increasing the touch-panel embedded display apparatus in size may distort the waveform of the driving signal, making accurate touch detection difficult.

It is desirable to provide a touch-panel embedded display apparatus that may be increased in size with the load of a driving electrode and the load of a detection electrode being reduced.

### SUMMARY

According to an aspect of the disclosure, there is provided a touch-panel embedded display apparatus including: a pixel electrode; a counter electrode arranged to face the pixel electrode and formed in a first layer; a driving electrode formed in the first layer; a detection electrode formed in the first layer and forming capacitance with the driving electrode; and an intermediate electrode formed in the first layer and arranged between two of the counter electrode, the driving electrode, and the detection electrode.

### BRIEF DESCRIPTION OF THE DRAWINGS

FIG. 1 is a block diagram illustrating the functional configuration of a display apparatus of a first embodiment;

FIG. 2 is a cross-sectional view of a touch panel;

FIG. 3 is a cross-sectional view of the touch pane;

FIG. 4 is a schematic plan view that illustrates how a gate driver, source driver, and thin-fil transistors are connected to each other;

FIG. 5 is a schematic circuit diagram that illustrates how the thin-film transistor, gate line, and source line are connected;

FIG. 6 is a schematic plan view that illustrates the layout of electrodes, first touch signal lines, and second touch signal lines in the first embodiment;

FIG. 7 illustrates the configuration of a gate line group;

FIG. 8 illustrates the configuration of a touch panel as a comparative example;

FIG. 9 illustrates the configuration of a display apparatus of a second embodiment;

FIG. 10 illustrates the configuration of a display apparatus of a third embodiment;

FIG. 11 illustrates the configuration of a display apparatus of a fourth embodiment; and

FIG. 12 illustrates the configuration of a display apparatus of a fifth embodiment.

### DESCRIPTION OF THE EMBODIMENTS

Embodiments of the disclosure are described in detail below with reference to the drawings. Elements that are the same as each other or identical to each other are designated with the same reference numerals and the discussion thereof is not repeated. To clarify the discussion, the drawings that are referenced below may be simplified, or schematized, or some elements may be omitted. The dimension ratio between the elements in each of the drawings may not be an actual dimension ratio.

### First Embodiment

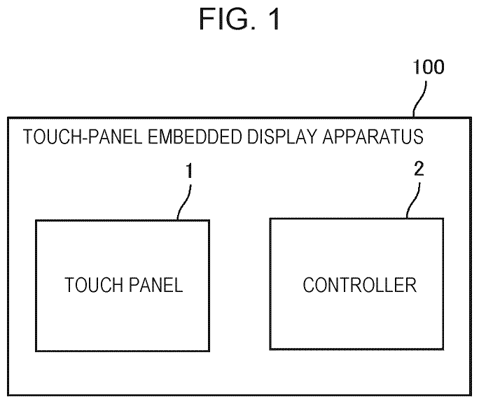

The configuration of a touch-panel embedded display apparatus 100 of a first embodiment (hereinafter referred to as a display apparatus 100) is described below. FIG. 1 is a block diagram illustrating the functional configuration of the display apparatus 100 of the first embodiment.

Referring to FIG. 1, the display apparatus 100 includes a touch panel 1 and controller 2. The touch panel 1 is a full-in-cell type touch panel. The touch panel 1 operates as a display panel that displays a video or an image. The controller 2 performs a control operation on the display apparatus 100 in accordance with touch detection information (for example, a touch position) acquired from the touch panel 1.

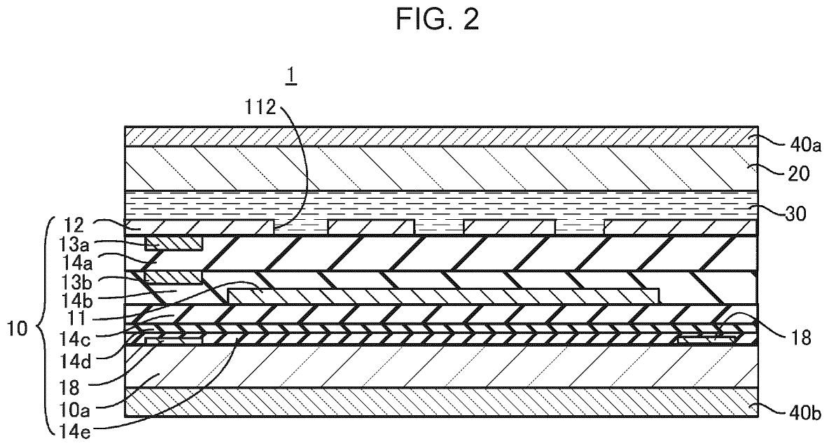

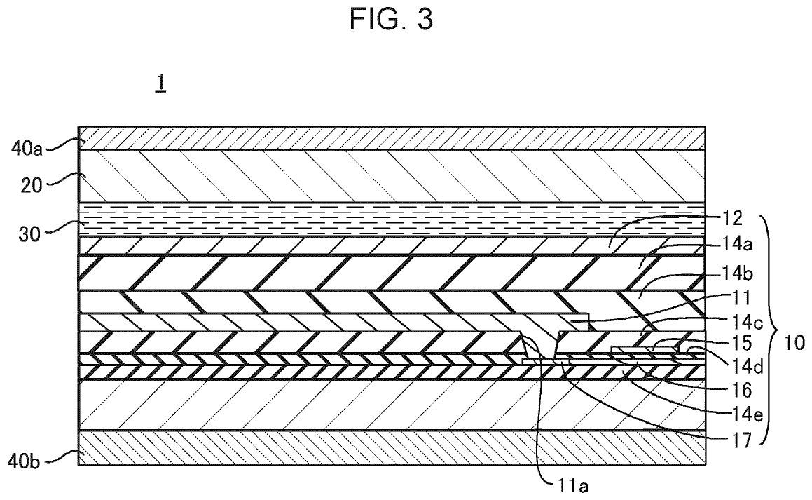

FIGS. 2 and 3 are cross-sectional views of the touch panel 1. As illustrated in FIG. 2, the touch panel 1 includes an active matrix substrate 10, counter substrate 20, and liquid-crystal layer 30 interposed between the active matrix substrate 10 and counter substrate 20. A pair of polarizing plates 40a and 40b are arranged to sandwich the active matrix substrate 10 and counter substrate 20. A color filter (not illustrated) is arranged on the counter substrate 20. A protective glass or the like (not illustrated) is mounted on the surface of the polarizing plate 40a. The outermost layer, such as the protective glass, forms a touch surface (a surface that a pointer touches). A user may recognize an image on the surface of the polarizing plate 40a. The touch panel 1 receives on the touch surface thereof a touch operation of a finger (pointer) or the like.

Liquid-crystal molecules contained in the liquid-crystal layer 30 in the touch panel 1 are driven in in-plane switching method. To perform in-plane switching, the active matrix substrate 10 includes, as illustrated in FIG. 2, pixel electrodes 11 and electrodes 12 that form electric fields. Each electrode 12 is one of a driving electrode 12a, detection electrode 12b, counter electrode 12c, and intermediate electrode 12d. When the driving electrode 12a, detection electrode 12b, counter electrode 12c, and intermediate electrode 12d are not differentiated from each other, the electrodes are referred to as the electrodes 12. The electrode 12 operates as a common electrode that faces multiple pixel electrodes 11. The electrode 12 is thus arranged to be common to the pixel electrodes 11. Referring to FIG. 2, the electrode 12 has one or more slits 112.

Referring to FIG. 2, the active matrix substrate 10 includes the electrode 12, first touch signal line 13a, first insulation layer 14a, second touch signal line 13b, second insulation layer 14b, pixel electrode 11, third insulation layer 14c, gate line 15 (see FIG. 3), fourth insulation layer 14d, semiconductor layer 16 (see FIG. 3), drain electrode 17 (see FIG. 3), fifth insulation layer 14e, source line 18, and glass substrate 10a, arranged from the touch surface the electrode 12 in that order. The electrode 12 is arranged to overlap the pixel electrode 11 in a plan view.

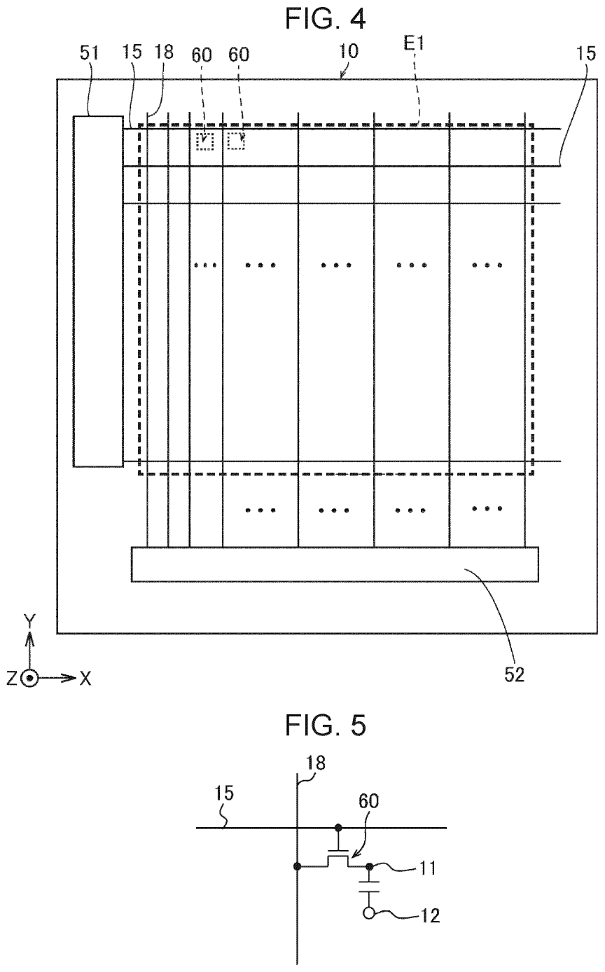

FIG. 4 is a schematic plan view that illustrates how a gate driver 51, source driver 52, and thin-film transistors 60 are connected. The active matrix substrate 10 includes the gate driver 51 and source driver 52. Multiple gate lines 15 and multiple source lines 18 mutually intersect in a grid pattern. Referring to FIG. 4, thin-film transistors 60 are respectively arranged in regions surrounded by the gate lines 15 and source lines 18.

FIG. 5 is a schematic circuit diagram illustrating how the thin-film transistor 60, gate line 15, and source line 18 are connected. Referring to FIG. 5, the gate electrode of the thin-film transistor 60 is connected to the gate line 15, and the source electrode of the thin-film transistor 60 is connected to the source line 18. The drain electrode of the thin-film transistor 60 is connected to the pixel electrode 11 via a contact hole 11a (see FIG. 3).

The gate lines 15 connect the thin-film transistors 60 to the gate driver 51. The source lines 18 connect the thin-film transistors 60 to the source driver 52. The gate driver 51 and source driver 52 are respectively arranged on frame regions outside a display region E1 (see FIG. 4) where the pixel electrodes 11 are arranged. The gate driver 51 may be manufactured by (monolithically) forming a circuit on the glass substrate 10a or manufactured of an integrated circuit. The source driver 52 is manufactured of, for example, an integrated circuit. The gate driver 51 successively supplies a gate signal (scanning signal) to the gate lines 15. Specifically, the gate driver 51 successively supplies a voltage to the gate lines 15 at a specific frequency (for scanning) in accordance with a horizontal synchronization signal from the controller 2. The source driver 52 supplies a source signal (data signal) to each of the source lines 18.

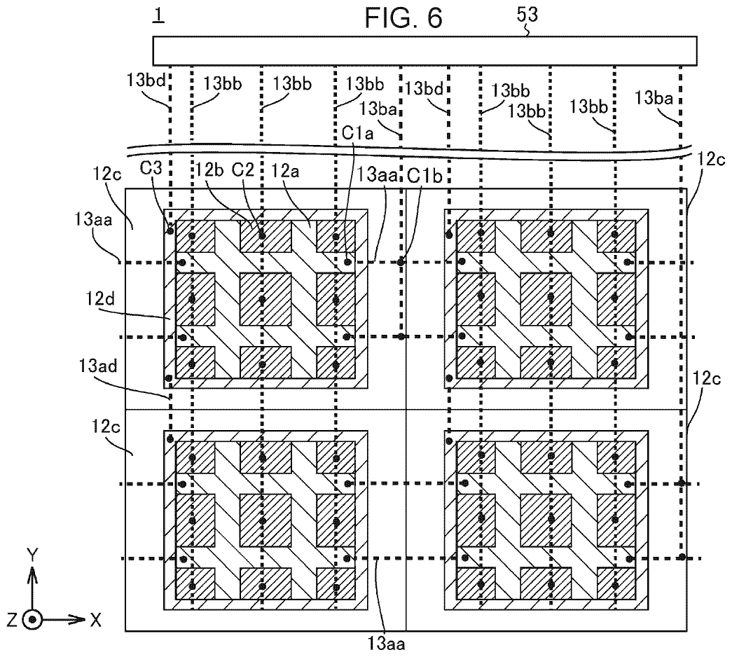

FIG. 6 is a schematic plan view that illustrates the layout of electrodes 12, first touch signal lines 13a and second touch signal lines 13b in the first embodiment. The electrodes 12 include a driving electrode 12a, detection electrodes 12b, counter electrode 12c, and intermediate electrode 12d. The driving electrodes 12a, detection electrodes 12b, counter electrodes 12c, and the intermediate electrodes 12d are formed in the same layer and manufactured of the same material (for example, Indium Tin Oxide (ITO)). The active matrix substrate 10 includes a touch detection driver 53. The first touch signal lines 13a include wirings 13aa connected to the driving electrodes 12a. The second touch signal lines 13b include wirings 13bb connected to the detection electrodes 12b, wirings (not illustrated) connected to the counter electrodes 12c, wirings 13bd connected to the intermediate electrodes 12d, and wirings 13ba that are connected to the wirings 13aa via contact holes C1b and connected to the touch detection driver 53. The electrodes 12 may be manufactured of a material (for example, a metal (copper, silver or gold)) other than ITO. The first touch signal lines 13a and second touch signal lines 13b are manufactured of, for example, a metal (copper, silver or gold).

As illustrated in FIG. 6, a portion of the counter electrode 12c and a portion of the intermediate electrode 12d are arranged between the driving electrodes 12a arranged side by side in the X direction. The driving electrodes 12a are connected to wirings 13aa via contact holes C1a. The driving electrodes 12a arranged side by side in the X direction are connected to each other via the wirings 13aa. The driving electrode 12a has a grid pattern including a portion extending in the X direction and a portion extending in the Y direction. The driving electrodes 12a are supplied successively row by row with a driving signal (with each row of driving electrodes 12a extending in the X direction).

Multiple detection electrodes 12b are arranged to fill gaps in the grid pattern of the driving electrodes 12a. Each detection electrode 12b is connected to the wiring 13bb via a contact hole C2. The detection electrode 12b forms capacitance with the driving electrode 12a. When a pointer is present between the detection electrode 12b and driving electrode 12a in this arrangement, the value of capacitance varies and a detection signal including information on the variation is input to the touch detection driver 53. The touch detection driver 53 determines the presence or absence of a touch of the pointer in response to the detection signal from the detection electrode 12b and detects a position of the touch.

The counter electrode 12c is formed to be rectangular (quadrilateral), surrounding the driving electrode 12a and detection electrodes 12b in a plan view. The counter electrode 12c is supplied with a voltage to generate an electric field with the pixel electrode 11. Since each counter electrode 12c is electrically isolated from the driving electrodes 12a and detection electrodes 12b, capacitance, resistance and the like of the counter electrode 12c do not serve as a load on the driving electrodes 12a and detection electrodes 12b. According to the first embodiment, the contact hole C1b and the wiring 13ba are arranged at locations that overlap the counter electrode 12c. In comparison with the case in which the contact hole C1b and the wiring 13ba are arranged at locations that overlap the detection electrode 12b, the loads of the contact hole C1b and wiring 13ba may be reduced.

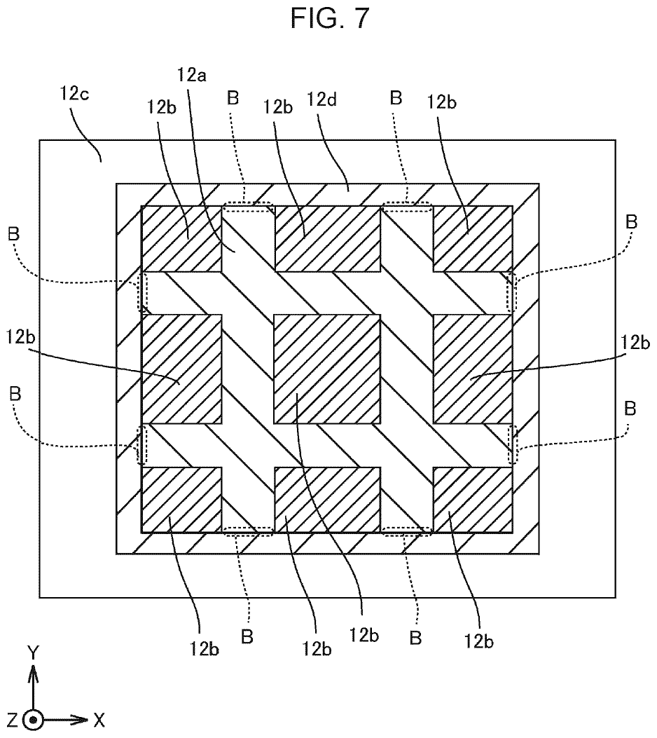

The intermediate electrode 12d is arranged between the detection electrodes 12b and counter electrode 12c and between the driving electrode 12a and counter electrode 12c as illustrated in FIG. 7. The intermediate electrode 12d operates to keep the detection electrodes 12b spaced from the counter electrode 12c (such that the detection electrodes 12b are not adjacent to the counter electrode 12c) and to keep the driving electrode 12a spaced from the counter electrode 12c (such that the driving electrode 12a is not adjacent to the counter electrode 12c). The intermediate electrode 12d is adjacent to the counter electrode 12c. The intermediate electrode 12d is shaped to be rectangular (quadrilateral), surrounding the driving electrode 12a and detection electrodes 12b. The intermediate electrode 12d is connected to the wiring 13bd via a contact hole C3. The intermediate electrode 12d is supplied with the same potential as the counter electrode 12c via the wiring 13bd. The intermediate electrode 12d is thus equal in potential to the counter electrode 12c.

A single pair of coordinates (unit cell (node)) in the touch detection is formed by the driving electrode 12a, nine detection electrodes 12b, counter electrode 12c, and intermediate electrode 12d as illustrated in FIG. 7. Since the counter electrode 12c and intermediate electrode 12d are included in a single unit cell (node), the areas of the driving electrode 12a and nine detection electrodes 12b per unit cell (node) are smaller and the load of the touch panel 1 may be reduced.

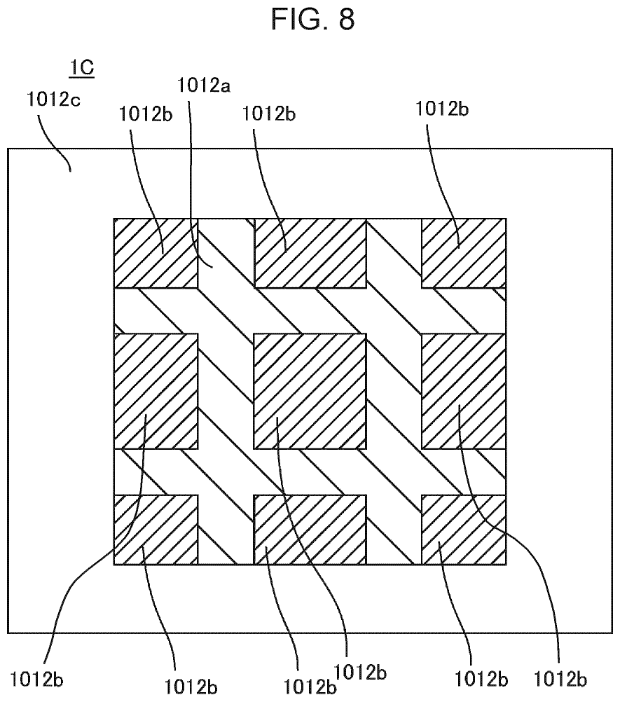

FIG. 8 illustrates the configuration of a touch panel 1C serving as a comparative example. The touch panel 1C as a comparative example is quoted in comparison with the touch panel 1 of the first embodiment but is not a relate-art technique. The touch panel 1C is different from the touch panel 1 in that the touch panel 1C does not include the intermediate electrode 12d. Referring to FIG. 8, a driving electrode 1012a and a counter electrode 1012c are arranged to be adjacent to each other in the touch panel 1C. Detection electrodes 1012b and the counter electrode 1012c are arranged to be adjacent to each other in the touch panel 1C. If the driving electrode 1012a is short-circuited to the counter electrode 1012c in the touch panel 1C, the entire counter electrode 1012c and a portion of the driving electrode 1012a adjacent to the counter electrode 1012c may be checked.

In contrast, according to the first embodiment illustrated in FIG. 7, the intermediate electrode 12d smaller in size than the counter electrode 12c (the counter electrode 1012c) is arranged between the counter electrode 12c and the driving electrode 12a. If the intermediate electrode 12d is short-circuited to the driving electrode 12a, the short-circuit location may be easily identified by checking the adjacent portions (labeled reference B as illustrated in FIG. 7) between the driving electrode 12a and intermediate electrode 12d. Since the short-circuit location may thus be easily identified in the touch panel 1 of the first embodiment, a correction operation to the short circuit may be quickly performed.

### Modifications of First Embodiment

According to the first embodiment, the touch detection driver 53 supplies the intermediate electrode 12d with the voltage equal to the voltage supplied to the counter electrode 12c. The disclosure is not limited to that configuration. For example, the touch detection driver 53 may supply the intermediate electrode 12d with the voltage equal to the voltage supplied to the detection electrode 12b (the touch detection driver 53 may be connected to the detection electrode 12b). In such a case, a short-circuit location may be identified in accordance with a fault in capacitance when the capacitance of the touch panel 1 is examined. The detection electrode 12b is equalized in potential to the counter electrode 12c, and a short-circuit location may be difficult to correct. In such a case, a detection signal from a short-circuited detection electrode 12b may be set to be out of use, and the touch detection may thus be normally performed on the touch panel 1.

### Second Embodiment

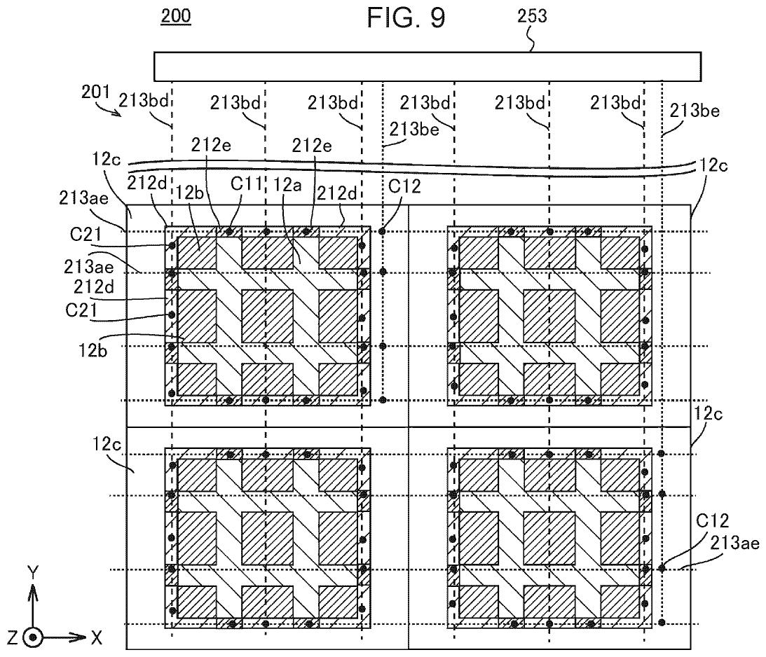

The configuration of a touch-panel embedded display apparatus 200 (hereinafter referred to as “display apparatus 200”) of a second embodiment is described with reference to FIG. 9. The display apparatus 200 includes a first intermediate electrode 212d arranged between the detection electrodes 12b and the counter electrode 12c and a second intermediate electrode 212e arranged between the driving electrode 12a and the counter electrode 12c. The use of the same reference numerals as in the first embodiment in the following discussion signifies the same configuration as in the first embodiment and unless otherwise noted, the previous discussion is applicable.

FIG. 9 illustrates the configuration of the display apparatus 200 of the second embodiment. The display apparatus 200 includes a touch panel 201 as illustrated in FIG. 9. The touch panel 201 includes multiple first intermediate electrodes 212d, multiple second intermediate electrodes 212e, multiple wirings 213ae, multiple wirings 213bd, multiple wirings 213be, and touch detection driver 253. The wiring 213ae is a first touch signal line and the wiring 213bd and wiring 213be is second touch signal lines. Each of the first intermediate electrodes 212d is arranged between the detection electrode 12b and the counter electrode 12c. The first intermediate electrodes 212d are connected to the wirings 213bd via contact holes C21. Each wiring 213bd extends in a Y direction and is connected to the touch detection driver 253. Each of the second intermediate electrodes 212e is arranged between the driving electrode 12a and the counter electrode 12c. The second intermediate electrodes 212e are connected to the wirings 213ae via contact holes C11. Each wiring 213ae extends in an X direction and is connected to the wiring 213be via a contact hole C12. Each wiring 213be extends in the Y direction and is connected to the touch detection driver 253. Note that FIG. 9 does not illustrate wirings that connect the touch detection driver 253 to the driving electrodes 12a, detection electrodes 12b, and counter electrodes 12c.

The touch detection driver 253 supplies the first intermediate electrodes 212d and second intermediate electrodes 212e with the voltage equal to the voltage supplied to the counter electrode 12c. The first intermediate electrodes 212d and second intermediate electrodes 212e are thus equal in potential to the counter electrode 12c. Since the counter electrode 12c, first intermediate electrodes 212d, and second intermediate electrodes 212e are included in a single unit cell (node), the areas of the driving electrode 12a and nine detection electrodes 12b are smaller on a per unit cell and the load of the touch panel 201 may be reduced even more.

The first intermediate electrodes 212d and second intermediate electrodes 212e are arranged in the second embodiment. If a detection electrode 12b is short-circuited to a first intermediate electrode 212d, a border of the first intermediate electrode 212d with the detection electrode 12b may be simply checked. If a driving electrode 12a is short-circuited to a second intermediate electrode 212e, a border portion the second intermediate electrode 212e with the driving electrode 12a may be simply checked. The short-circuit location may thus be easily identified. The rest of the configuration and effect of the second embodiment is identical to those of the first embodiment.

### Modifications of Second Embodiment

According to the second embodiment, the touch detection driver 253 is configured to supply the first intermediate electrode 212d and second intermediate electrode 212e with the voltage equal to the voltage supplied to the counter electrode 12c. The disclosure is not limited to that configuration. In order to acquire a larger signal, the touch detection driver 253 may be configured to supply the first intermediate electrode 212d with the voltage equal to the voltage supplied to the counter electrode 12c and to supply the second intermediate electrode 212e with the voltage equal to the voltage supplied to the driving electrode 12a. Alternatively, the touch detection driver 253 is configured to supply the first intermediate electrode 212d with the voltage equal to the voltage supplied to the detection electrodes 12b and to supply the second intermediate electrode 212e with the voltage equal to the voltage supplied to the counter electrode 12c. Alternatively, the touch detection driver 253 is configured to supply the first intermediate electrode 212d with the voltage equal to the voltage supplied to the detection electrodes 12b and to supply the second intermediate electrode 212e with the voltage equal to the voltage supplied to the driving electrode 12a.

### Third Embodiment

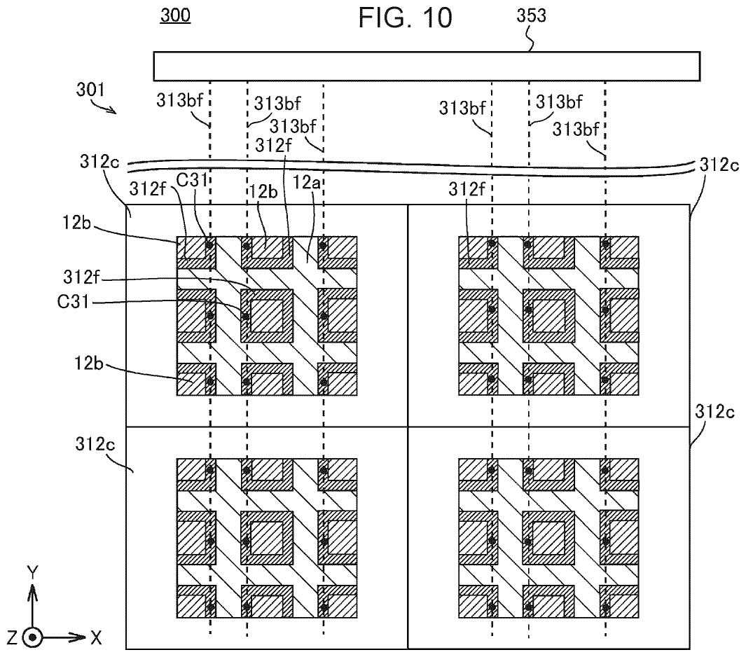

The configuration of a touch-panel embedded display apparatus 300 (hereinafter referred to as display apparatus 300) of a third embodiment is described below with reference to FIG. 10. The display apparatus 300 includes an intermediate electrode 312f between the driving electrode 12a and each of the detection electrodes 12b. The use of the same reference numerals as in the first embodiment in the following discussion signifies the same configuration as in the first embodiment and unless otherwise noted, the previous discussion is applicable.

FIG. 10 illustrates the configuration of the display apparatus 300 of the third embodiment. The display apparatus 300 includes a touch panel 301 as illustrated in FIG. 10. The touch panel 301 includes the detection electrode 312c, multiple intermediate electrodes 312f, multiple wirings 313bf, and touch detection driver 353. Note that the wiring 313bf is the second touch signal. The intermediate electrodes 312f are arranged between the driving electrode 12a and the detection electrodes 12b. The intermediate electrodes 312f are connected to the wirings 313bf via contact holes C31. Each wiring 313bf extends in the Y direction and is connected to the touch detection driver 353. Unlike in the first embodiment, the detection electrode 312c is adjacent to the driving electrode 12a and the detection electrodes 12b. Note that FIG. 10 does not illustrate wirings that connect the touch detection driver 353 to the driving electrode 12a, detection electrodes 12b, and detection electrode 312c.

The touch detection driver 353 supplies the intermediate electrodes 312f with the voltage equal to the voltage supplied to the detection electrode 312c. The intermediate electrode 312f is thus equal in potential to the detection electrode 312c. Since the detection electrode 312c and the intermediate electrodes 312f are included in a single unit cell (node), the areas of the driving electrode 12a and nine detection electrodes 12b per unit cell are smaller and the load of the touch panel 301 may be reduced.

The intermediate electrodes 312f are employed in the third embodiment, and if the driving electrode 12a is short-circuited to a detection electrode 12b, the border portion of the intermediate electrode 312f with the driving electrode 12a may be simply checked. In this way, the short-circuit location may be easily identified. The rest of the configuration and effect of the third embodiment is identical to those of the first embodiment.

### Modifications of Third Embodiment

According to the third embodiment, the touch detection driver 353 supplies the intermediate electrodes 312f with the voltage equal to the voltage supplied to the counter electrode 12c. The disclosure is not limited to that configuration. In order to acquire a larger signal, the touch detection driver 353 is configured to supply the intermediate electrodes 312f with the voltage equal to the voltage supplied to the driving electrode 12a or with the voltage equal to the voltage supplied to the detection electrodes 12b.

### Fourth Embodiment

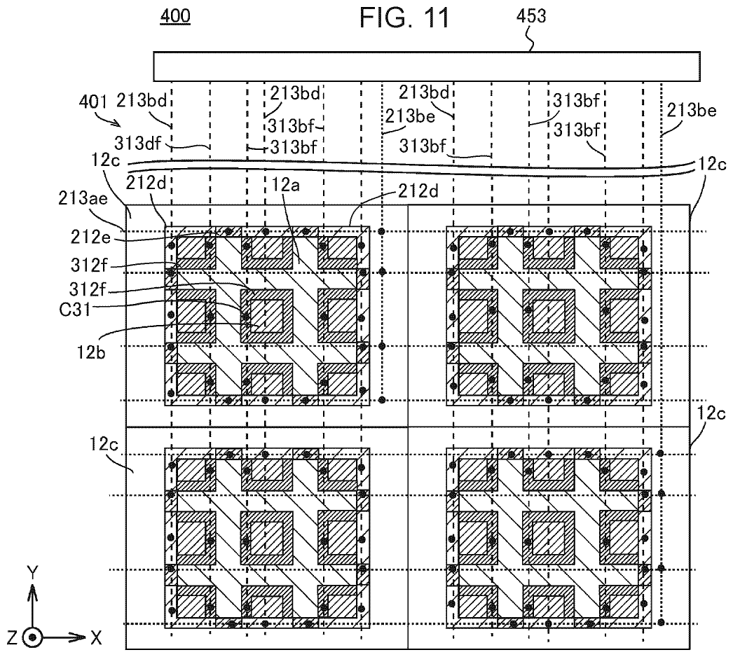

The configuration of a touch-panel embedded display apparatus 400 (hereinafter referred to as display apparatus 400) of a fourth embodiment is described below with reference to FIG. 11. The display apparatus 400 includes the first intermediate electrodes 212d and second intermediate electrode 212e illustrated with reference to the second embodiment and the intermediate electrodes 312f illustrated with reference to the third embodiment. The use of the same reference numerals as in one of the first through third embodiments in the following discussion signifies the same configuration as in the first through third embodiments and unless otherwise noted, the previous discussion is applicable.

FIG. 11 illustrates the configuration of the display apparatus 400 of the fourth embodiment. As illustrated in FIG. 11, the display apparatus 400 includes a touch panel 401. The touch panel 401 includes multiple first intermediate electrodes 212d, multiple second intermediate electrodes 212e, multiple wirings 213ae, multiple wirings 213bd, multiple wirings 213be, multiple intermediate electrodes 312f, multiple wirings 313bf, and touch detection driver 453. The touch detection driver 453 is configured to supply a voltage to the first intermediate electrodes 212d, second intermediate electrodes 212e, and intermediate electrodes 312f. In this way, the fourth embodiment may provide the effect of the second embodiment and the effect of the third embodiment.

### Fifth Embodiment

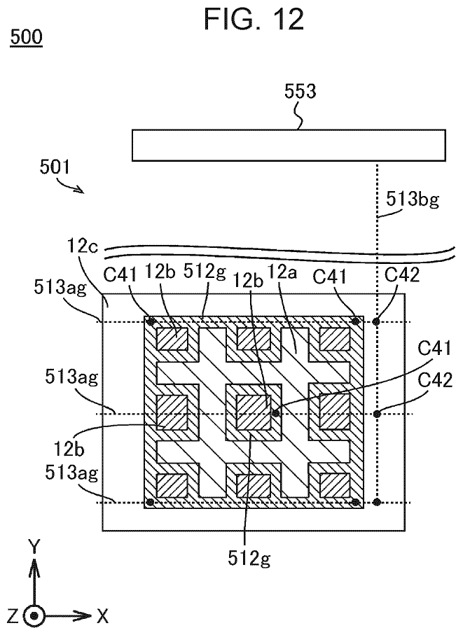

The configuration of a touch-panel embedded display apparatus 500 (hereinafter referred to as display apparatus 500) of a fifth embodiment is described below with reference to FIG. 12. The display apparatus 500 includes an intermediate electrode 512g into which the first intermediate electrodes 212d and second intermediate electrodes 212e illustrated with reference to the second embodiment and the intermediate electrodes 312f illustrated with reference to the third embodiment are formed as a unitary body. The use of the same reference numerals as in one of the first through fourth embodiments in the following discussion signifies the same configuration as in one of the first through fourth embodiments and unless otherwise noted, the previous discussion is applicable.

FIG. 12 illustrates the configuration of the display apparatus 500 of the fifth embodiment. The display apparatus 500 includes a touch panel 501 as illustrated in FIG. 12. The touch panel 501 includes the intermediate electrode 512g, wirings 513ag, wiring 513bg, and touch detection driver 553. The intermediate electrode 512g is arranged between the driving electrode 12a and detection electrodes 12b and between the detection electrodes 12b and counter electrode 12 c. The intermediate electrode 512g is a unitary body into which the first intermediate electrodes 212d and second intermediate electrodes 212e illustrated with reference to the second embodiment and the intermediate electrodes 312f illustrated with reference to the third embodiment are integrated. The touch detection driver 553 supplies the intermediate electrode 512g with a voltage. That voltage is equal to the voltage supplied to the counter electrode 12c or may be equal to the voltage supplied to the driving electrode 12a or may be equal to the voltage supplied to the detection electrode 12b. Note that the rest of the configuration and effect of the fifth embodiment are identical to those of the fourth embodiment.

### Modifications

The embodiments and modifications thereof have been described for exemplary purposes only. The disclosure is not limited to the above-described embodiments and the above-described embodiments may be implemented in a varied form without departing from the scope of the disclosure.

(1) According to the first through fifth embodiments, the counter electrode is arranged to surround the driving electrode and detection electrodes. The disclosure is not limited to that configuration. For example, the counter electrode may be arranged on the side of the driving electrode or the side of the detection electrode.

(2) According to the first through fifth embodiments, the first touch signal line is arranged in a layer higher than the second touch signal line. The disclosure is not limited to that configuration. For example, the first touch signal line may be arranged in a layer lower than the second touch signal line.

(3) According to the first through fifth embodiments, each driving electrode has a grid pattern, each detection electrode is formed to be rectangular, and each intermediate electrode is formed to be rectangular or in a frame shape. The disclosure is not limited to that configuration. The driving electrode may be formed to be rectangular, circular or may have a frame shape, the detection electrode may have a grid pattern or may be formed to be circular, and the intermediate electrode may be formed to be circular or in a likewise pattern.

(3) According to the first through fifth embodiments, the intermediate electrode is supplied with the voltage equal to the voltage supplied to one of the driving electrode, detection electrode, and counter electrode but, alternatively, the intermediate electrode is supplied with a voltage different from the voltages supplied to the driving electrode, detection electrode, and counter electrode.

(4) According to the first embodiment, the contact hole C1b connecting the wiring 13aa to the wiring 13ba is arranged to overlap the counter electrode 12c in a plan view. The disclosure is not limited to that configuration. The contact hole C1b may be arranged at a location overlapping the driving electrode 12a or detection electrode 12b in a plan view.

The configurations described above may also be described as below.

A touch-panel embedded display apparatus in a first configuration includes a pixel electrode; a counter electrode arranged to face the pixel electrode and formed in a first layer; a driving electrode formed in the first layer; a detection electrode formed in the first layer and forming capacitance with the driving electrode; and an intermediate electrode formed in the first layer and arranged between two of the counter electrode, the driving electrode, and the detection electrode (first configuration).

According to the first configuration, the arrangement of the counter electrodes in the touch-panel embedded display apparatus including the counter electrodes may lead to reducing the size of each driving electrode and the size of each detection electrode. The load of the driving electrode and the load of the detection electrode may thus be reduced. With the load of the driving electrode and the load of the detection electrode reduced, the touch-panel embedded display apparatus may be increased in size. The intermediate electrode is arranged between two of the counter electrode, driving electrode, and detection electrode. Even if a short circuit occurs between electrodes, a short-circuit location may be easily identified by checking a border portion of the intermediate electrode with an electrode of another type. The first configuration may thus allow the short-circuit location to be easily identified, leading a quick correction to the short circuit.

In the first configuration, the intermediate electrode may be arranged between the counter electrode and one of the driving electrode and the detection electrode. The intermediate electrode may be equal in potential to the counter electrode (second configuration).

According to the second configuration, even if a short circuit occurs between the intermediate electrode and one of the driving electrode and detection electrode, the short-circuit location may be easily identified by checking a border location between the intermediate electrode and one of the driving electrode and detection electrode. The second configuration may thus allow the short-circuit location to be easily identified, leading a quick correction to the short circuit.

The intermediate electrode in the second configuration may surround the driving electrode and the detection electrode in a plan view. The counter electrode may surround the intermediate electrode in a plan view (third configuration).

According to the third configuration, even if a short circuit occurs, that short circuit may occur between the driving electrode or detection electrode and the intermediate electrode. The short-circuit location may thus be easily identified.

The intermediate electrode in one of the second and third configurations may include a first electrode arranged between the counter electrode and one of the driving electrode and the detection electrode; and a second electrode arranged between the counter electrode and the other of the driving electrode and the detection electrode (fourth configuration).

According to the fourth configuration, a short-circuit location may be easily identified regardless of whether the short circuit occurs between the intermediate electrode and driving electrode or between the intermediate electrode and detection electrode.

The intermediate electrode in one of the first through fourth configurations may be arranged between the driving electrode and the detection electrode (fifth configuration).

According to the fifth configuration, a short circuit may be easily identified regardless of whether the short circuit occurs between the intermediate electrode and driving electrode or between the intermediate electrode and detection electrode.

The touch-panel embedded display apparatus in one of the first through fifth configurations may further include an intermediate electrode wiring formed in a second layer different from the first layer and connected to the intermediate electrode via a contact hole (sixth configuration).

According to the sixth configuration, the intermediate electrode may be supplied with a specific voltage via the intermediate electrode wiring.

According to one of the first through sixth configurations, the intermediate electrode may be arranged between the counter electrode and the detection electrode. The intermediate electrode may be equal in potential to the detection electrode (seventh configuration).

According to the seventh configuration, a short-circuit location may be identified in accordance with a fault in capacitance when the capacitance of the touch panel is tested.

The present disclosure contains subject matter related to that disclosed in Japanese Priority Patent Application JP 2024-196870 filed in the Japan Patent Office on Nov. 11, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A touch-panel embedded display apparatus comprising:
a pixel electrode;
a counter electrode arranged to face the pixel electrode and formed in a first layer;
a driving electrode formed in the first layer;
a detection electrode formed in the first layer and forming capacitance with the driving electrode; and
an intermediate electrode formed in the first layer and arranged between two of the counter electrode, the driving electrode, and the detection electrode.

2. The touch-panel embedded display apparatus according to claim 1, wherein the intermediate electrode is arranged between the counter electrode and one of the driving electrode and the detection electrode, and
wherein the intermediate electrode is equal in potential to the counter electrode.

3. The touch-panel embedded display apparatus according to claim 2, wherein the intermediate electrode surrounds the driving electrode and the detection electrode in a plan view, and
wherein the counter electrode surrounds the intermediate electrode in a plan view.

4. The touch-panel embedded display apparatus according to claim 2, wherein the intermediate electrode comprises:
a first electrode arranged between the counter electrode and one of the driving electrode and the detection electrode; and
a second electrode arranged between the counter electrode and the other of the driving electrode and the detection electrode.

5. The touch-panel embedded display apparatus according to claim 1, wherein the intermediate electrode is arranged between the driving electrode and the detection electrode.

6. The touch-panel embedded display apparatus according to claim 1, further comprising an intermediate electrode wiring formed in a second layer different from the first layer and connected to the intermediate electrode via a contact hole.

7. The touch-panel embedded display apparatus according to claim 1, wherein the intermediate electrode is arranged between the counter electrode and the detection electrode, and
wherein the intermediate electrode is equal in potential to the detection electrode.
